(19) United States
(12) Patent Application Publication
(10) Pub. No.: US 2017/0267156 A1
(43) Pub. Date: Sep. 21, 2017

(54) POLYETHYLENE TEREPHTHALATE DUNNAGE BAGS AND PROCESSES FOR MANUFACTURING POLYETHYLENE TEREPHTHALATE DUNNAGE BAGS

(71) Applicant: Signode Industrial Group LLC, Glenview, IL (US)

(72) Inventors: Anthony K. Beard, Poyen, AR (US); Joseph W. Gault, Sheridan, AR (US); Joseph E. Lininger, Union Grove, WI (US); Gurpreet S. Chhiber, Wheeling, IL (US)

(21) Appl. No.: 15/448,005

(22) Filed: Mar. 2, 2017

Related U.S. Application Data
(60) Provisional application No. 62/310,247, filed on Mar. 18, 2016.
(60) Provisional application No. 62/372,601, filed on Aug. 9, 2016.

(51) Int. Cl. B60P 7/06; B29C 65/00; B29C 65/02; B29C 65/08; B65D 81/05; B29C 65/48

(52) U.S. Cl. CPC B60P 7/065; B65D 81/052; B29C 65/48; B29C 65/02; B29C 65/08; B29C 66/729; B29C 66/712; B29C 66/8511; B29C 66/432; B29K 2023/0625

(57) ABSTRACT

The present disclosure is directed to dunnage bags formed using polyethylene terephthalate (PET) and processes for manufacturing these PET dunnage bags. Generally, the PET dunnage bags of the present disclosure include a PET outer bag, an inner bladder enclosed within the PET outer bag, and a valve assembly that enables air to be introduced into (or escape out of) the inner bladder to inflate (or deflate) the inner bladder, thereby inflating (or deflating) the PET dunnage bag.

### PRIORITY CLAIM

This patent application claims priority to and the benefit of U.S. Provisional Patent Application No. 62/310,247, which was filed on Mar. 18, 2016, and U.S. Provisional Patent Application No. 62/372,601, which was filed on Aug. 9, 2016, the entire contents of each of which are incorporated herein by reference.

### BACKGROUND

Inflatable dunnage bags are commonly used to stabilize cargo during transportation of cargo containers (such as railroad cars and semi-trailers), which reduces the likelihood that the cargo will be damaged. Typical dunnage bags include an outer bag made of either paper or polypropylene, an inner bladder enclosed within the outer bag, and a valve assembly that enables air to be introduced into (or escape out of) the inner bladder to inflate (or deflate) the inner bladder, thereby inflating (or deflating) the dunnage bag.

In operation, a user inserts a deflated or partially deflated dunnage bag into a void between cargo or between cargo and the walls of the cargo container. The user attaches an air source to the valve and inflates the dunnage bag to a desired pressure. This causes the dunnage bag to expand to fill the void such that the dunnage bag engages the cargo and the adjacent cargo or the adjacent cargo container wall to secure the cargo against undesirable movement during transit.

These known dunnage bags having paper or polypropylene outer bags are problematic. Paper outer bags are not water-resistant, and are more prone to tearing or degrading when wet. Polypropylene outer bags tend to stretch upon initial inflation of the inner bladder, which reduces the air pressure inside the dunnage bag and either results in suboptimal dunnage bag performance or requires an operator to “top off” the dunnage bag with additional air after the outer bag has stretched. Polypropylene outer bags are also more time consuming to manufacture since the inner bladders cannot be heat sealed from the outside through the polypropylene outer bag without degrading the polypropylene, but rather must be sealed before insertion into the polypropylene outer bags. Further, the open ends of the outer bags of certain dunnage bags are stitched closed, which requires the use of machinery with many moving—and breakable—parts.

There is a continuing need for new and improved dunnage bags and processes for making dunnage bags that solve the above problems.

### SUMMARY

The present disclosure is directed to dunnage bags formed using polyethylene terephthalate (PET) and processes for manufacturing these PET dunnage bags. Generally, the PET dunnage bags of the present disclosure include a PET outer bag, an inner bladder enclosed within the PET outer bag, and a valve assembly that enables air to be introduced into (or escape out of) the inner bladder to inflate (or deflate) the inner bladder, thereby inflating (or deflating) the PET dunnage bag.

In certain embodiments, a PET dunnage bag is formed using a sheet of woven PET formed by looming a plurality of PET tapes together. To manufacture these embodiments of the woven PET dunnage bag, the sheet of woven PET is wrapped around linear low-density polyethylene (LLDPE) formed into a tube shape, and a segment of the tube of LLDPE wrapped in the sheet of woven PET is cut to size. A valve assembly is installed in and sealed to the tube of LLDPE, and the open ends of the tube of LLDPE are sealed to form an inner bladder. The open ends of the sheet of woven PET are then closed, forming a woven PET dunnage bag including an outer woven PET bag that encloses the inner bladder.

In other embodiments, a PET dunnage bag is formed using a tube of circular-loomed woven PET formed by looming a plurality of PET tapes into a tube shape. To manufacture these embodiments of the woven PET dunnage bag, an inner bladder is formed from a tube of LLDPE, and a valve assembly is sealed to the inner bladder. A segment of the tube of woven PET is cut to size. The inner bladder is inserted into the interior of the segment of the tube of woven PET. The open ends of the segment of the tube of woven PET are closed such that the tube of woven PET forms an outer bag that encloses the inner bladder, thereby forming the woven PET dunnage bag.

In further embodiments, a PET dunnage bag is formed using a tube of circular-loomed woven PET and two end closures (which are sheets of woven PET). To manufacture these embodiments of the woven PET dunnage bag, an inner bladder is formed from a tube of LLDPE, and a valve assembly is sealed to the inner bladder. A segment of the tube of woven PET is cut to size. The inner bladder is inserted into the interior of the segment of the tube of woven PET. Each end closure is folded over one of the open ends of the tube of woven PET and attached to the tube of woven PET to close that open end, which forms an outer bag that encloses the inner bladder. This forms the woven PET dunnage bag.

The PET dunnage bags of the present disclosure solve the above-described problems. Unlike paper, PET is water-resistant, and the PET outer bags are therefore less likely to degrade or tear when wet than paper outer bags. PET is more dimensionally stable than polypropylene, and the PET outer bags therefore stretch much less than polypropylene outer bags upon initial inflation of the inner bladder. The PET dunnage bags of the present disclosure thus combine the water-resistant qualities of polypropylene dunnage bags with the dimensional stability of paper dunnage bags, thereby providing higher quality, more robust dunnage bags that can be produced more quickly than certain known dunnage bags.

Also, the inner bladders of the PET dunnage bags can be heat sealed from the outside through the PET outer bags without degrading the PET in certain methods of manufacture, rendering the PET dunnage bags less time consuming to manufacture in this manner than dunnage bags having polypropylene outer bags. Further, the outer bags of the PET dunnage bags can be closed via heat sealing in certain methods of manufacture, eliminating the need for complex machinery with many moving (and breakable) parts.

Additional features and advantages are described herein, and will be apparent from, the following Detailed Description and the Figures.

### BRIEF DESCRIPTION OF THE FIGURES

FIG. 1 is a top plan view of one embodiment of a woven PET dunnage bag of the present disclosure.

FIG. 2 is a front elevational cross-sectional view of the woven PET dunnage bag of FIG. 1 taken substantially along line 2-2 of FIG. 1.

FIG. 3 is a side elevational cross-sectional view of the woven PET dunnage bag of FIG. 1 taken substantially along line 3-3 of FIG. 1.

FIG. 4 is a flowchart of an example process of manufacturing the woven PET dunnage bag of FIG. 1.

FIG. 5 is a diagrammatic view of example components used to implement part of the process of FIG. 4 to manufacture the woven PET dunnage bag of FIG. 1.

FIG. 6 is a top plan view of another embodiment of a woven PET dunnage bag of the present disclosure.

FIG. 7 is a front elevational cross-sectional view of the woven PET dunnage bag of FIG. 6 taken substantially along line 7-7 of FIG. 6.

FIG. 8 is a side elevational cross-sectional view of the woven PET dunnage bag of FIG. 6 taken substantially along line 8-8 of FIG. 6.

FIG. 9 is a flowchart of an example process of manufacturing the woven PET dunnage bag of FIG. 6.

FIG. 10 is a top plan view of another embodiment of a woven PET dunnage bag of the present disclosure.

FIG. 11 is a front elevational cross-sectional view of the woven PET dunnage bag of FIG. 10 taken substantially along line 11-11 of FIG. 10.

FIG. 12 is a side elevational cross-sectional view of the woven PET dunnage bag of FIG. 10 taken substantially along line 12-12 of FIG. 10.

FIG. 13 is a flowchart of an example process of manufacturing the woven PET dunnage bag of FIG. 10.

### DETAILED DESCRIPTION

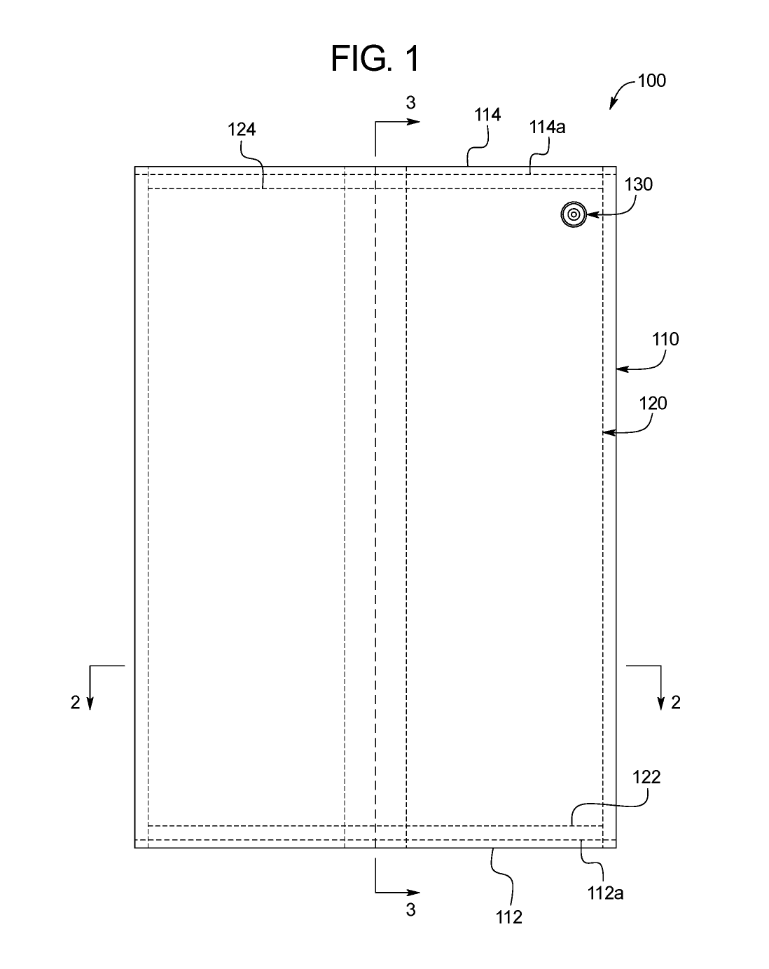

FIGS. 1,2, and 3 illustrate one embodiment of a woven PET dunnage bag 100 of the present disclosure manufactured using a sheet of woven PET. The woven PET dunnage bag 100 includes a woven PET outer bag 110, an inner bladder 120 enclosed within the woven PET outer bag 110, and a valve assembly 130 that enables air to be introduced into (or escape out of) the inner bladder 120 to inflate (or deflate) the inner bladder 120, thereby inflating (or deflating) the woven PET dunnage bag 100.

The outer bag 110 is formed using a sheet of woven PET formed by looming a plurality of PET tapes together, as described in U.S. Patent Application Publication No. 2013/0189461 and/or U.S. Patent Application Publication No. 2014/0322463. In certain embodiments, the PET tapes in the warp direction are thicker (and therefore stronger) than those in the weft direction. In other embodiments, the PET tapes in the weft direction are thicker (and therefore stronger) than those in the warp direction. This enables one to customize the desired properties of the woven PET. The inner bladder 120 is formed using LLDPE formed into a tube shape, though any other suitable material may be used, such as low-density polyethylene (LDPE), high-density polyethylene (HDPE), polypropylene (PP), coextruded LLDPE, or mono-LLDPE. The valve assembly 130 is any suitable valve assembly usable with dunnage bags, such as that described in U.S. Patent Application Publication No. 2015/0037113, or a recessed valve.

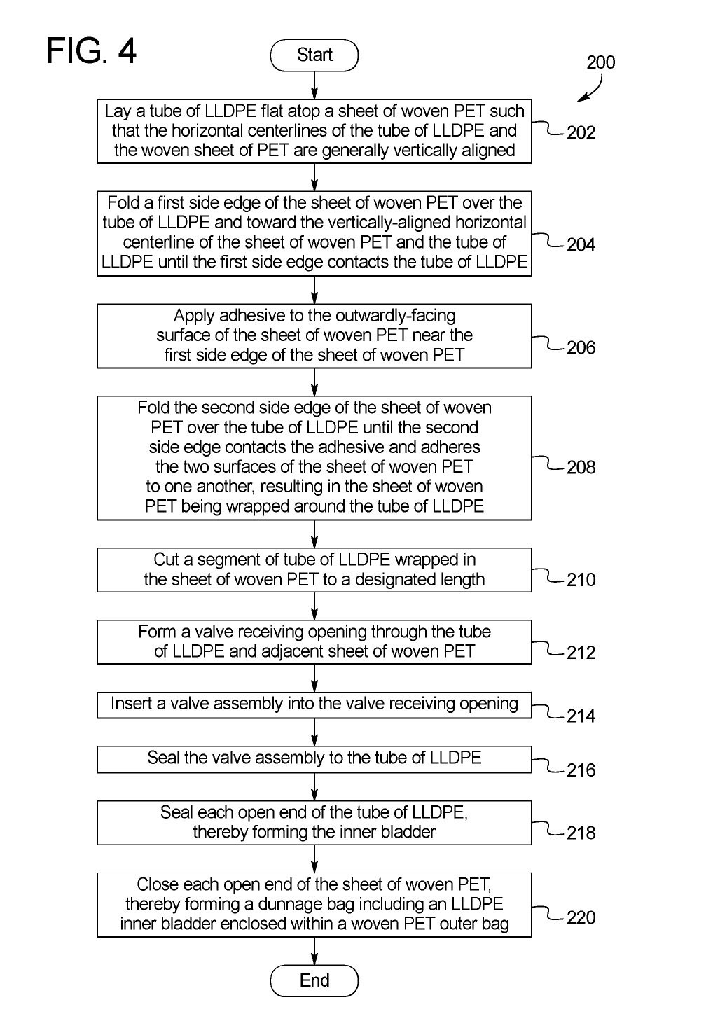

FIG. 4 is a flowchart of a process 100 for manufacturing woven PET dunnage bags using a sheet of woven PET. The order of the steps of this process may vary and is not limited to the order explained below. Generally, the sheet of woven PET is wrapped around the tube of LLDPE, and a segment of the tube of LLDPE wrapped in the sheet of woven PET is cut to size. A valve assembly is installed in and sealed to the tube of LLDPE, and the open ends of the tube of LLDPE are sealed to form an inner bladder. The open ends of the sheet of woven PET are then closed, forming a woven PET dunnage bag including an outer woven PET bag that encloses the inner bladder.

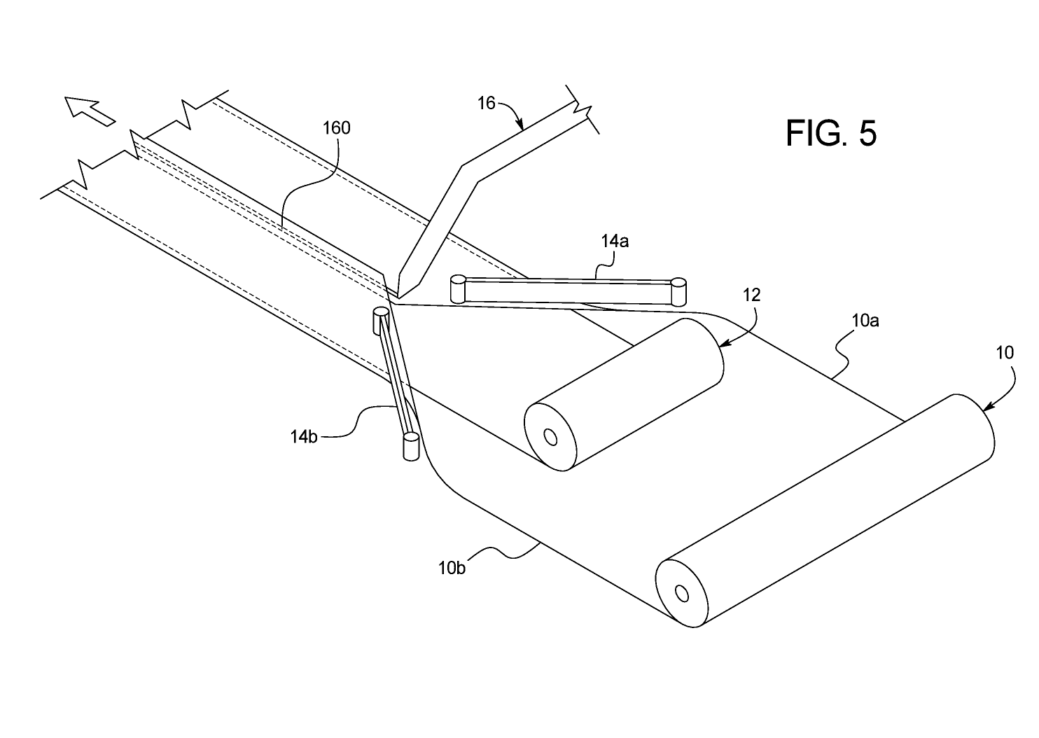

More specifically, according to process 100, the tube of LLDPE is laid flat atop the sheet of woven PET such that the horizontal centerlines of the tube of LLDPE and the sheet of woven PET are generally vertically aligned, as indicated by block 202. In one embodiment, as shown in FIG. 5, the LLDPE and woven PET are pulled off of respective rolls 12 and 10 positioned such that the tube of LLDPE pulled off of its roll is atop the sheet of woven PET pulled off of its roll and positioned such that their horizontal centerlines are generally vertically aligned. In other embodiments, the horizontal centerlines of the tube of LLDPE and the sheet of woven PET are offset from one another.

The sheet of woven PET is folded and adhered to itself to form a tube of woven PET that wraps around and encloses the tube of LLDPE, as described below. A first side edge of the sheet of woven PET is folded over the tube of LLDPE and toward the vertically-aligned horizontal centerlines of the sheet of woven PET and the tube of LLDPE until the first side edge contacts the tube of LLDPE, as indicated by block 204. Adhesive is applied to the outwardly-facing surface of the sheet of woven PET near the first side edge of the sheet of woven PET, as indicated by block 206. The folding process is completed by folding the second side edge over the tube of LLDPE until the second side edge contacts the outwardly-facing surface of the sheet of woven PET near the first side edge of the sheet of woven PET such that the adhesive adheres the sheet of woven PET to itself (and not to the tube of LLDPE wrapped within the sheet of woven PET), as indicated by block 208.

In the embodiment shown in FIG. 5, woven PET and LLDPE are pulled off of their respective rolls 10 and 12 and through fold aid devices 14a and 14b by a suitable device (not shown). The fold aid devices 14a and 14b cause the side edges 10a and 10b of the sheet of woven PET to fold over the tube of LLDPE and inward toward the vertically-aligned horizontal centerlines of the sheet of woven PET and the tube of LLDPE. In this embodiment, an adhesive applicator 16 applies an adhesive 160 to the outwardly-facing surface of the sheet of woven PET near the edge 10a before the edge 10b contacts the outwardly-facing surface of the sheet of woven PET near the first side edge 10a. In this embodiment, the adhesive applicator 16 applies the adhesive in a location generally vertically aligned with the horizontal centerlines of the sheet of woven PET and the tube of LLDPE, though the adhesive may be applied in any suitable location. The adhesive may be any suitable adhesive, such as (but not limited to) hot melt glue or an extruded thermoplastic adhesive.

A segment of the tube of LLDPE wrapped in the formed tube of woven PET is cut to a designated length, as indicated by block 210. In one embodiment, one uses a cutting device to cut the segment of the tube of LLDPE wrapped in the formed tube of woven PET to the designated length. In another embodiment, this cutting is automated.

A valve-receiving opening is formed through the tube of LLDPE and adjacent sheet of woven PET near one of the open ends of the segment, as indicated by block 212. In one embodiment, one uses a hole-punching device to punch the valve-receiving openings near one of the open ends. An automatic hole-punching device may also be used. The valve-receiving opening may be located at any suitable location and is not limited to that shown in the drawings.

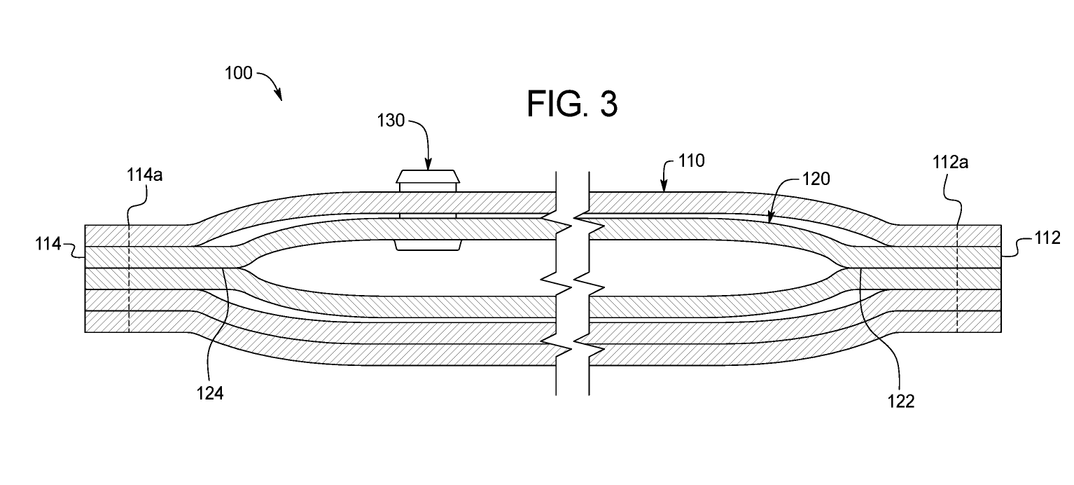

A valve assembly is inserted into the valve-receiving opening in the tube of LLDPE and the adjacent sheet of woven PET, as indicated by block 214. In one embodiment, one inserts the valve assembly 130 into the valve-receiving opening from the inside of the tube of LLDPE out such that a portion of the valve assembly passes through the valve-receiving openings and protrudes from the formed tube of woven PET while another portion of the valve assembly remains disposed within the interior of the tube of LLDPE. The location and orientation of the valve assembly 130 with respect to the inner bladder 120 (formed by the tube of LLDPE) and the outer bag 110 (formed by the sheet of woven PET) is best shown in FIG. 3.

The valve assembly is sealed to the tube of LLDPE, as indicated by block 216. In one embodiment, one uses a valve sealing device to heat seal a portion of the tube of LLDPE to a sealing flange of the valve assembly 130. In one embodiment, the valve sealing device does so even though the sheet of woven PET is disposed between the tube of LLDPE and the valve sealing device during the sealing process. In other words, in this embodiment, the valve sealing device heat seals the portion of the tube of LLDPE to the sealing flange of the valve assembly through the sheet of woven PET. The tube of LLDPE may be sealed to any suitable portion of the valve (such as the bottom of the valve) in any suitable manner (such as via adhesive).

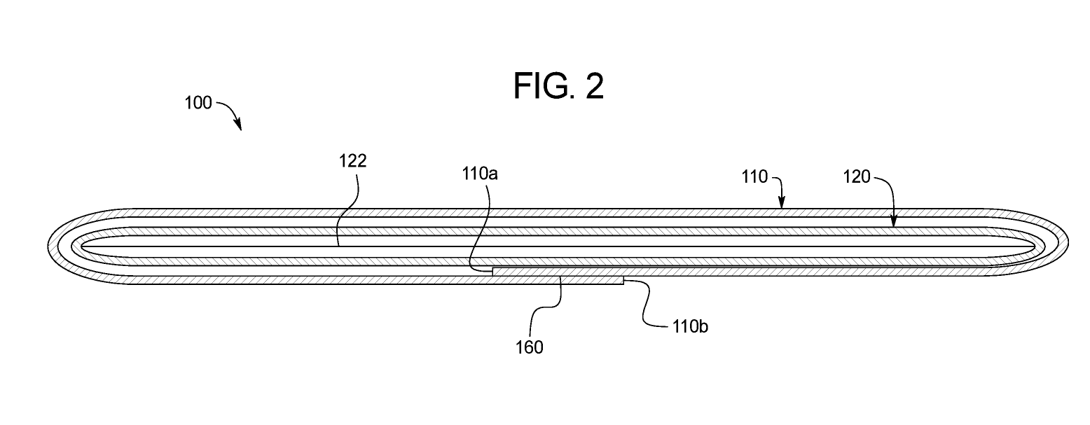

Each open end of the tube of LLDPE is sealed to form generally linear first and second sealed ends, thereby forming an inner bladder, as indicated by block 218. In one embodiment, one uses a sealing device to heat seal the open ends of the segment of the tube of LLDPE to form the generally linear first and second sealed ends. In one embodiment, the sealing device does so even though the sheet of woven PET is disposed between the tube of LLDPE and the sealing device during the sealing process. In other words, in this embodiment, the sealing device heat seals the open ends of the tube of LLDPE through the sheet of woven PET (though the open ends of the tube of LLDPE may be sealed in other suitable manners, such as via adhesive). Sealing these open ends forms the inner bladder 120 of the woven PET dunnage bag 100. FIG. 1 (as hidden lines) and FIGS. 2 and 3 show these generally linear first and second sealed ends 122 and 124.

The seals of the inner bladder 120—i.e., the seals that form the generally linear first and second sealed ends of the tube of LLDPE and the seal that seals the valve assembly to the segment of the tube of LLDPE—are airtight in that air cannot enter or exit the interior of the inner bladder 120 via these seals.

The open ends of the formed tube of woven PET are then closed to form generally linear, opposing first and second closed ends, as indicated by block 220. In one embodiment, one stitches the open ends together—such as via a sewing machine—to form the generally linear, opposing first and second closed ends. The open ends of the formed tube of woven PET may be closed in any other suitable manner, such as via adhesive, ultrasonic welding, or heat sealing. FIGS. 1 and 3 show these generally linear, opposing first and second closed ends 112 and 114 and their corresponding stitching 112a and 114a.

After the open ends are closed, the outer bag 110 may or may not be airtight.

This process 100 thus forms the woven PET dunnage bag 100 including the LLDPE inner bladder 120 enclosed within the woven PET outer bag 110.

In certain embodiments, the valve assembly is a two-piece assembly that includes first and second separable pieces. In one such embodiment, the first piece of the valve assembly is inserted into the valve-receiving openings of the tube of LLDPE and the adjacent sheet of woven PET and sealed to the tube of LLDPE. At some point thereafter (such as after the ends of the outer bag are closed), the second piece is attached to the first piece to form the complete valve assembly.

Although the above process was described as employing woven PET, non-woven PET may be used instead.

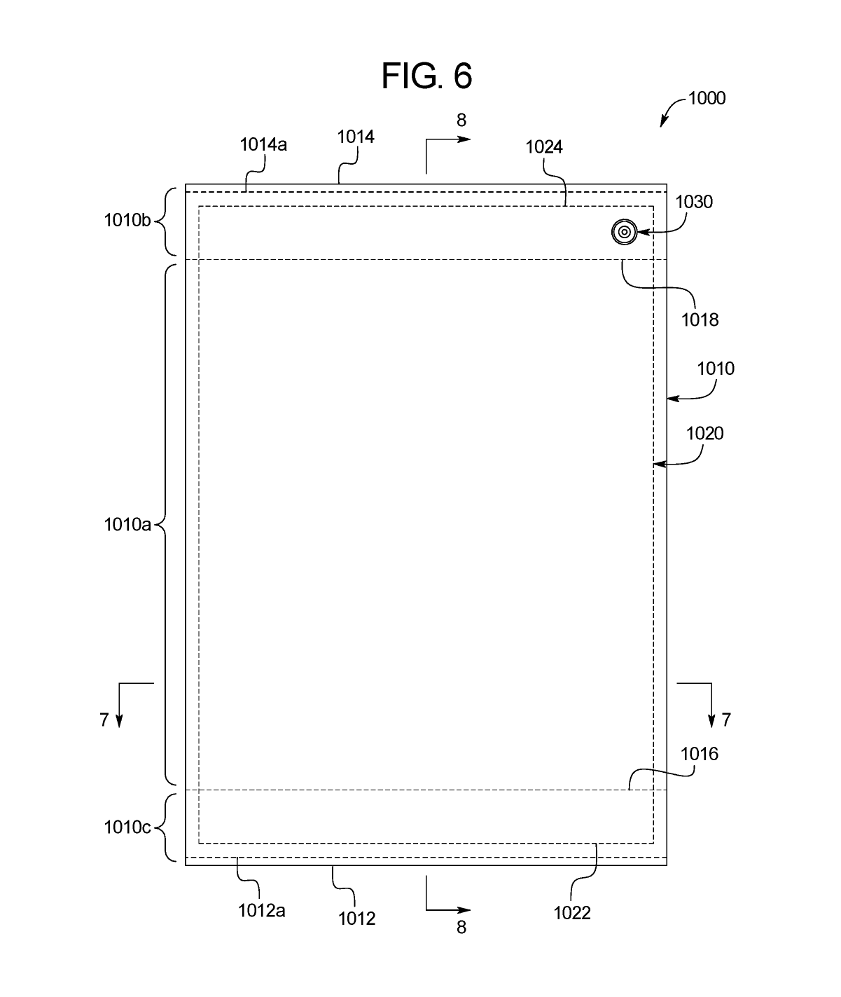

FIGS. 6, 7, and 8 illustrate one embodiment of a woven PET dunnage bag 1000 of the present disclosure manufactured using a tube of circular-loomed woven PET. The woven PET dunnage bag 1000 includes a woven PET outer bag 1010, an inner bladder 1020 enclosed within the woven PET outer bag 1010, and a valve assembly 1030 that enables air to be introduced into (or escape out of) the inner bladder 1020 to inflate (or deflate) the inner bladder 1020, thereby inflating (or deflating) the woven PET dunnage bag 1000.

The outer bag 1010 is formed using tube of woven PET, formed by looming a plurality of PET tapes together into a tube shape, as described in U.S. Patent Application Publication No. 2013/0189461 and/or U.S. Patent Application Publication No. 2014/0322463. In certain embodiments, the thickness of the PET tapes that form the tube of woven PET differs based on direction. In certain embodiments, the PET tapes in the warp direction are thicker (and therefore stronger) than those in the weft direction. In other embodiments, the PET tapes in the weft direction are thicker (and therefore stronger) than those in the warp direction. This enables one to customize the desired properties of the tube of woven PET. The inner bladder 1020 is formed using a tube of LLDPE (or any other suitable material, such as any of the materials described above for the inner bladder 120). The valve assembly 1030 is any suitable valve assembly, as described above.

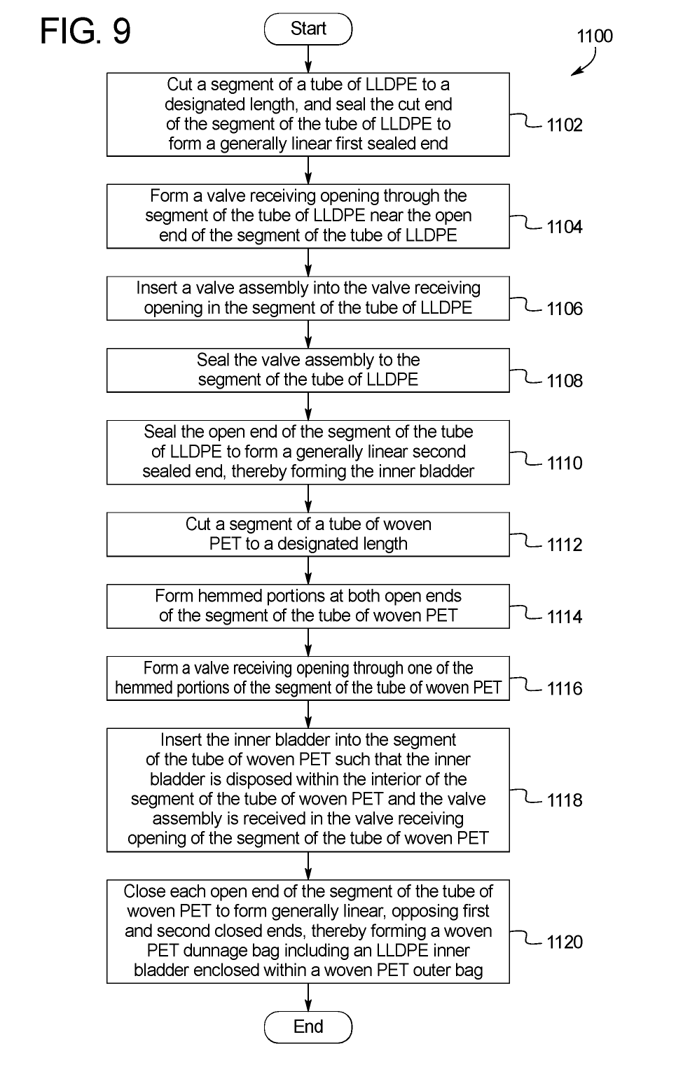

FIG. 9 is a flowchart of a process 1100 for manufacturing woven PET dunnage bags using a tube of woven PET. The order of the steps of this process may vary and is not limited to the order explained below. Generally, an inner bladder is formed from a tube of LLDPE, and a valve assembly is sealed to the inner bladder. A segment of the tube of woven PET is cut to size. The inner bladder is inserted into the interior of the segment of the tube of woven PET. The open ends of the segment of the tube of woven PET are closed such that the tube of woven PET forms an outer bag that encloses the inner bladder, thereby forming the woven PET dunnage bag.

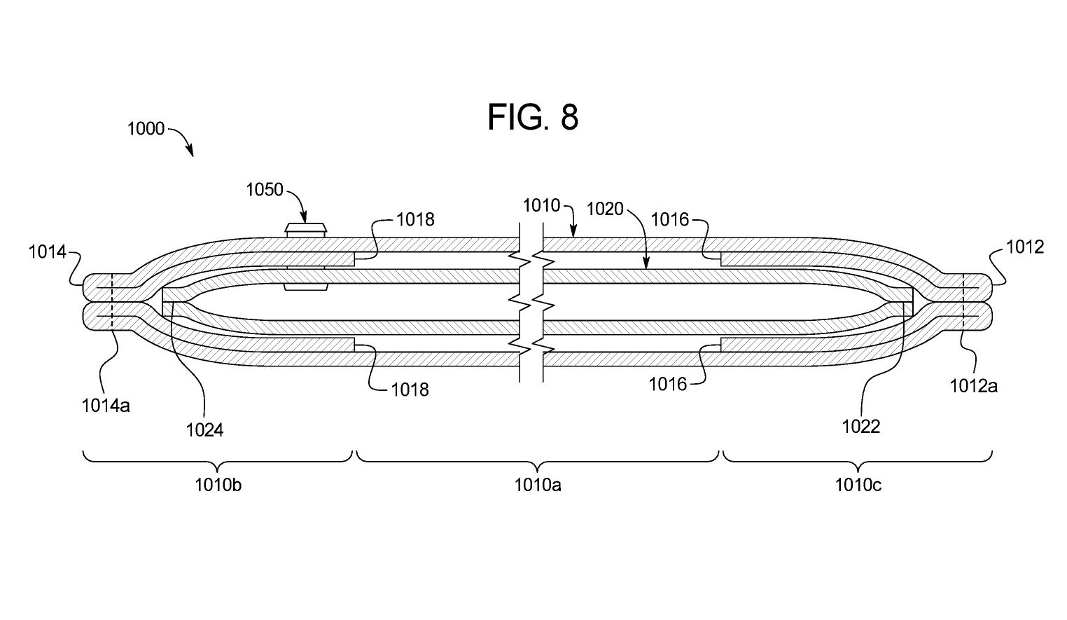

More specifically, according to process 1100, a segment of the tube of LLDPE is cut to a designated length, and the cut end of the segment of the tube of LLDPE is sealed to form a generally linear first sealed end, as indicated by block 1102. At this point, the other end of the segment of the tube of LLDPE remains open. In one embodiment, one pulls tubular LLDPE off of a roll to the designated length, and uses a combination cutting and sealing device (or separate cutting and sealing devices) to cut the segment of the tube of LLDPE and to heat seal the cut end to form a generally linear first sealed end. FIG. 6 (as a hidden line) and FIG. 8 show this generally linear first sealed end 1022.

A valve-receiving opening is formed through the segment of the tube of LLDPE near the open end of the segment of the tube of LLDPE, as indicated by block 1104. In one embodiment, one uses a hole-punching device to punch the valve-receiving opening through the segment of the tube of LLDPE near the open end of the segment of the tube of LLDPE. An automatic hole-punching device may also be used. The valve-receiving opening may be located at any suitable location and is not limited to that shown in the drawings.

A valve assembly is inserted into the valve-receiving opening in the segment of the tube of LLDPE, as indicated by block 1106. In one embodiment, one inserts the valve assembly 1030 into the valve-receiving opening in the segment of the tube of LLDPE from the inside of the segment of the tube of LLDPE out such that a portion of the valve assembly passes through the valve-receiving opening and protrudes from the segment of the tube of LLDPE while another portion of the valve assembly remains disposed within the interior of the segment of the tube of LLDPE. The location and orientation of the valve assembly 1030 with respect to the inner bladder 1020 (formed by the segment of the tube of LLDPE) and the outer bag 1010 (described below) is best shown in FIG. 8.

The valve assembly is sealed to the segment of the tube of LLDPE, as indicated by block 1108. In one embodiment, one uses a valve sealing device to heat seal a portion of the segment of the tube of LLDPE to a sealing flange of the valve assembly 1030 (which is disposed within the interior of the segment of the tube of LLDPE).

The open end of the segment of the tube of LLDPE is sealed to form a generally linear second sealed end, thereby forming an inner bladder, as indicated by block 1110. In one embodiment, one uses a sealing device to heat seal the open end of the segment of the tube of LLDPE to form the generally linear second sealed end (though the open ends of the segments of the tube of LLDPE may be sealed in other suitable manners, such as via adhesive). Sealing the open end forms the inner bladder 1020 of the woven PET dunnage bag 1000. FIG. 6 (as a hidden line) and FIG. 8 show this generally linear second sealed end 1024.

The seals of the inner bladder 1020—i.e., the seals that form the generally linear first and second sealed ends of the tube of LLDPE and the seal that seals the valve assembly to the segment of the tube of LLDPE—are airtight in that air cannot enter or exit the interior of the inner bladder 1020 via these seals.

A segment of the tube of woven PET is cut to a designated length, as indicated by block 1112. In one embodiment, one pulls tubular woven PET off of a roll to the designated length and uses a cutting device to cut the segment of the tube of woven PET.

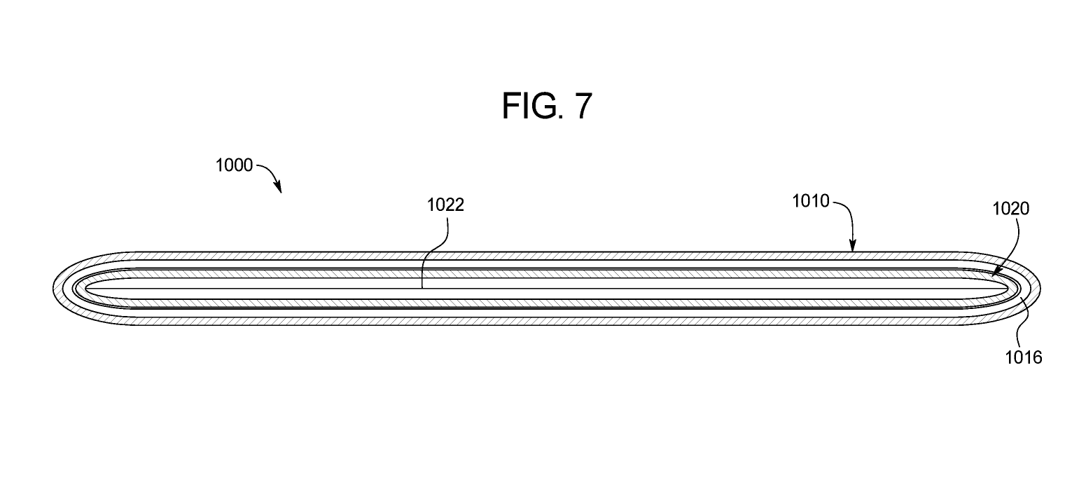

Hemmed, double-thick portions are formed at both open ends of the segment of the tube of woven PET, as indicated by block 1114. In one embodiment, one forms the hemmed portions at both open ends of the segment of the tube of woven PET by folding a portion of the tube of woven PET back inside itself at each open end. In another embodiment, one does the opposite and forms the hemmed portions at both open ends of the segment of the tube of woven PET by folding the portion of the tube of woven PET over the outside of itself at each open end. This provides the woven PET dunnage bag 1000 edge strength and enables the open ends of the segment of the tube of woven PET to be more securely sewn together to form the outer bag 1010 (as described below). FIGS. 6 and 8 indicate the hemmed portions 1010b and 1010c and the non-hemmed portion 1010a. FIG. 6 (as hidden lines) and FIGS. 7 and 8 show the ends of the hemmed portions of the segment of the tube of woven PET 1016 and 1018 disposed within the segment of the tube of woven PET. In certain embodiments, at each open end one stitches, adheres, ultrasonically welds, or otherwise attaches (1) the two upper layers of the hemmed portion to one another, and (2) the two lower layers of the hemmed portion to one another. In other embodiments, the hemmed portions are not formed.

A valve-receiving opening that corresponds to the valve-receiving opening of the inner bladder 1020 is formed through one of the hemmed portions of the segment of the tube of woven PET, as indicated by block 1116. In one embodiment, one uses a hole-punching device to punch the valve-receiving opening through the hemmed portion of the segment of the tube of woven PET. An automatic hole-punching device may also be used. The valve-receiving opening may be formed through any suitable portion of the segment of the tube of woven PET.

The inner bladder is inserted into the interior of the segment of the tube of woven PET (such as by folding the inner bladder, inserting it into the interior of the segment of the tube of woven PET, then unfolding it) such that: (1) the inner bladder is entirely or almost entirely disposed within the interior of the segment of the tube of woven PET, and (2) the valve assembly is received in the valve-receiving opening in the segment of the tube of woven PET such that a portion of the valve assembly passes through the valve-receiving opening and protrudes from the segment of the tube of woven PET, as indicated by block 1118. In one embodiment, one manually inserts the inner bladder 1020 into the interior of the segment of the tube of woven PET and positions the inner bladder 1020 such that the inner bladder 1020 is entirely disposed within the interior of the segment of the tube of woven PET and the valve assembly 1030 is received in the valve-receiving opening of the segment of the tube of woven PET. In some embodiments, the inner bladder is longer than the segment of the tube of woven PET, and one must fold the inner bladder onto itself such that it fits within the interior of the segment of the tube of woven PET and does not interfere with the sealing of the ends of the segment of the tube of woven PET (described below).

The open ends of the segment of the tube of woven PET are then closed to form generally linear, opposing first and second sealed ends, as indicated by block 1120. In one embodiment, one stitches the open ends together—such as via a sewing machine—to form the generally linear, opposing first and second closed ends. FIGS. 6 and 8 show these generally linear, opposing first and second closed ends 1012 and 1014 and their corresponding stitching 1012a and 1014a. The open ends of the segment of the tube of woven PET may be closed in any other suitable manner, such as via adhesive, ultrasonic welding, or heat sealing.

After the open ends are closed, the outer bag 110 may or may not be airtight.

This process 1000 thus forms the woven PET dunnage bag 1000 including the LLDPE inner bladder 1020 enclosed within the woven PET outer bag 1010.

In certain embodiments, the valve assembly is a two-piece assembly that includes first and second separable pieces. In one such embodiment, the first piece of the valve assembly is inserted into the valve-receiving opening of the tube of LLDPE and sealed to the tube of LLDPE. At some point thereafter (such as after the ends of the outer bag are closed), the second piece is attached to the first piece to form the complete valve assembly.

Although the above process was described as employing woven PET, non-woven PET may be used instead.

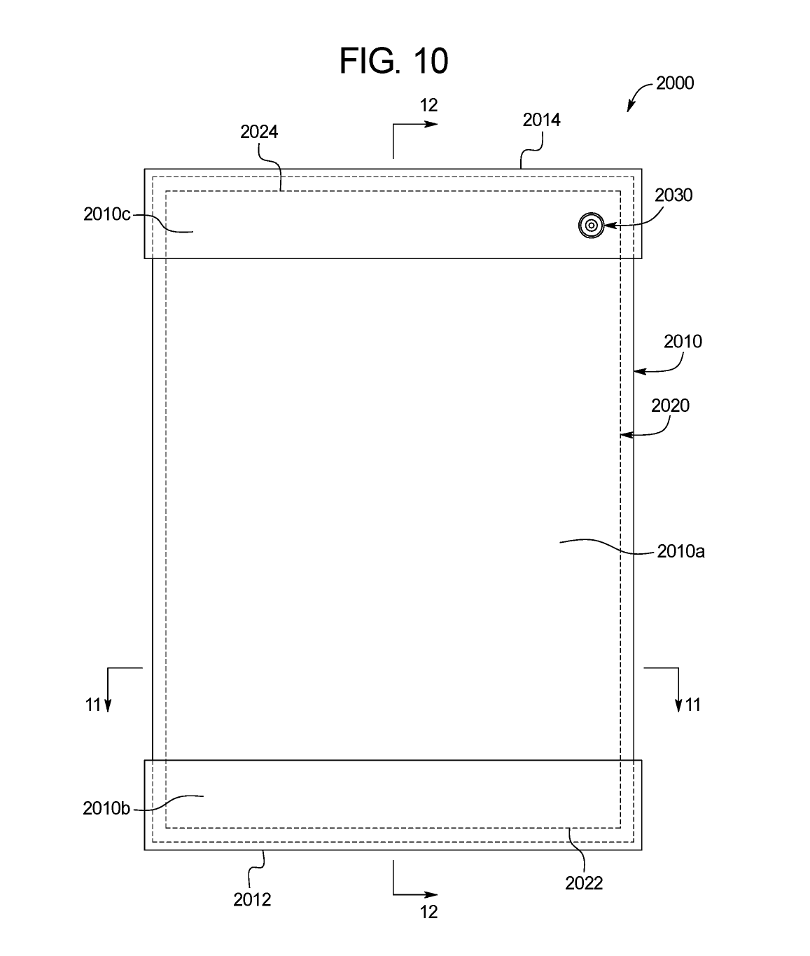

FIGS. 10, 11, and 12 illustrate one embodiment of a woven PET dunnage bag 2000 of the present disclosure having a three-piece outer bag manufactured using a tube of circular-loomed woven PET and two end closures, which are sheets of woven PET. The woven PET dunnage bag 2000 includes a woven PET outer bag 2010, an inner bladder 2020 enclosed within the woven PET outer bag 2010, and a valve assembly 2030 that enables air to be introduced into (or escape out of) the inner bladder 2020 to inflate (or deflate) the inner bladder 2020, thereby inflating (or deflating) the woven PET dunnage bag 2000.

The outer bag 2010 is formed using: (1) a segment of a tube of woven PET 2010a (formed as described above); and (2) two end closures 2010b and 2010c, which are sheets of woven PET (formed as described above). The inner bladder 2020 is formed using a tube of LLDPE (or any other suitable material, such as any of the materials described above for the inner bladder 120). The valve assembly 2030 is any suitable valve assembly, as described above.

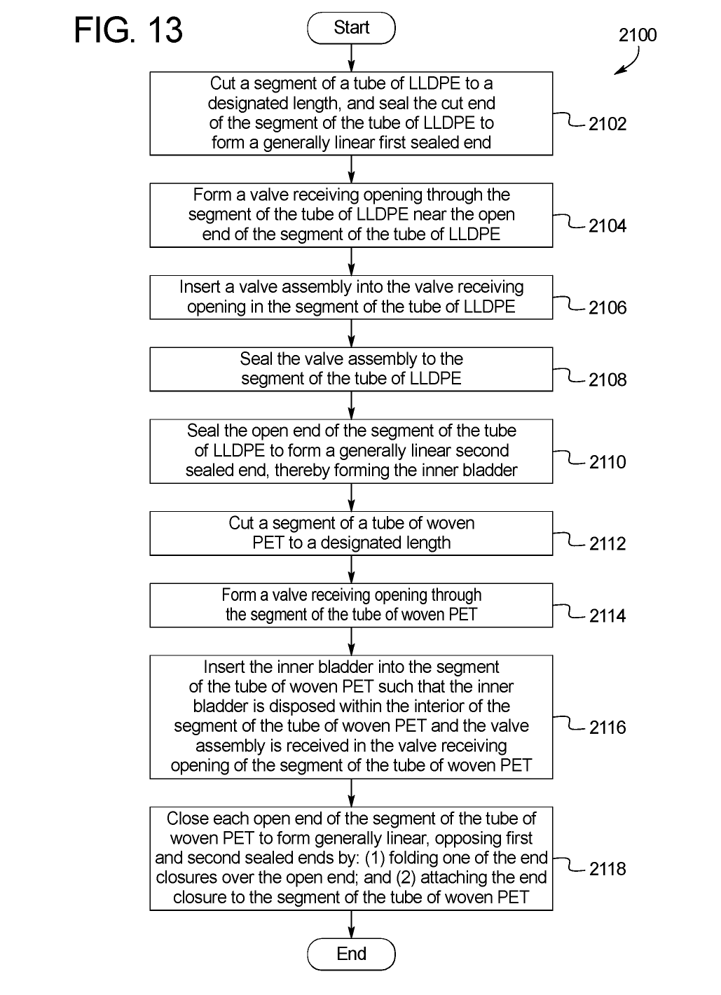

FIG. 13 is a flowchart of a process 2100 for manufacturing woven PET dunnage bags using a tube of woven PET and two end closures. The order of the steps of this process may vary and is not limited to the order explained below. Generally, an inner bladder is formed from a tube of LLDPE, and a valve assembly is sealed to the inner bladder. A segment of the tube of woven PET is cut to size. The inner bladder is inserted into the interior of the segment of the tube of woven PET. Each end closure is folded over one of the open ends of the tube of woven PET and attached to the tube of woven PET to close that open end, which forms an outer bag that encloses the inner bladder. This forms the woven PET dunnage bag.

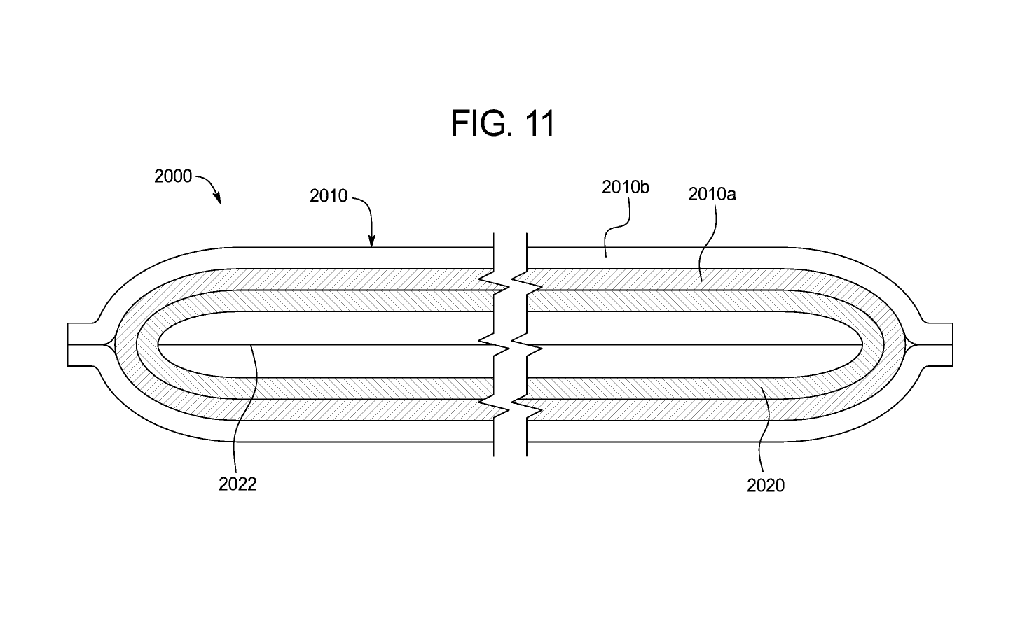

More specifically, according to process 2100, a segment of the tube of LLDPE is cut to a designated length, and the cut end of the segment of the tube of LLDPE is sealed to form a generally linear first sealed end, as indicated by block 2102. At this point, the other end of the segment of the tube of LLDPE remains open. In one embodiment, one pulls tubular LLDPE off of a roll to the designated length, and uses a combination cutting and sealing device (or separate cutting and sealing devices) to cut the segment of the tube of LLDPE and to heat seal the cut end to form a generally linear first sealed end. FIG. 10 (as a hidden line) and FIG. 11 best show this generally linear first sealed end 2022.

A valve-receiving opening is formed through the segment of the tube of LLDPE near the open end of the segment of the tube of LLDPE, as indicated by block 2104. In one embodiment, one uses a hole-punching device to punch the valve-receiving opening through the segment of the tube of LLDPE near the open end of the segment of the tube of LLDPE. An automatic hole-punching device may also be used. The valve-receiving opening may be located at any suitable location and is not limited to that shown in the drawings.

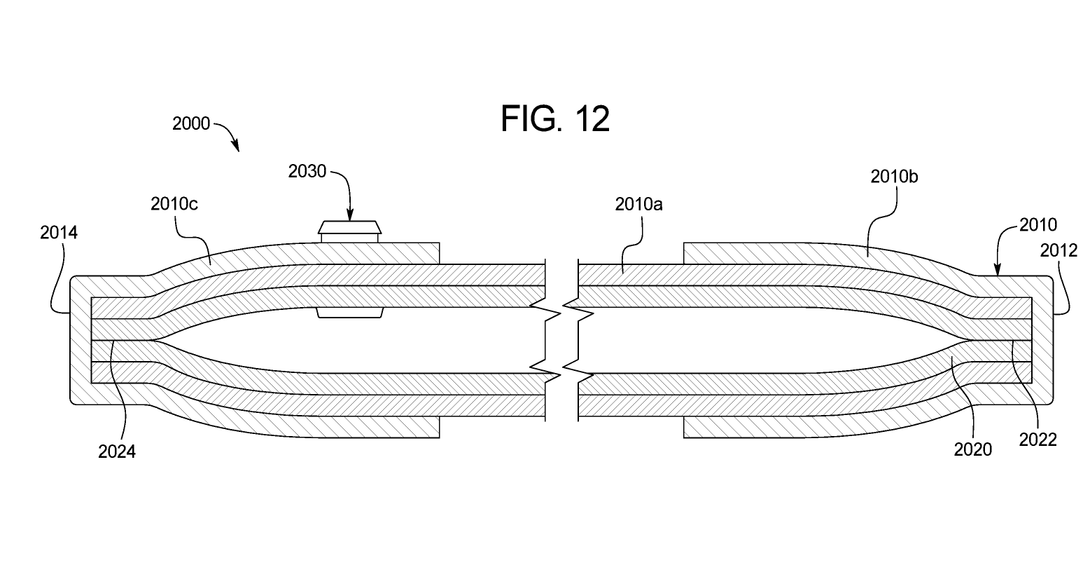

A valve assembly is inserted into the valve-receiving opening in the segment of the tube of LLDPE, as indicated by block 2106. In one embodiment, one inserts the valve assembly 2030 into the valve-receiving opening in the segment of the tube of LLDPE from the inside of the segment of the tube of LLDPE out such that a portion of the valve assembly passes through the valve-receiving opening and protrudes from the segment of the tube of LLDPE while another portion of the valve assembly remains disposed within the interior of the segment of the tube of LLDPE. The location and orientation of the valve assembly 2030 with respect to the inner bladder 2020 (formed by the segment of the tube of LLDPE) and the outer bag 2010 (described below) is best shown in FIG. 12.

The valve assembly is sealed to the segment of the tube of LLDPE, as indicated by block 2108. In one embodiment, one uses a valve sealing device to heat seal a portion of the segment of the tube of LLDPE to a sealing flange of the valve assembly 2030 (which is disposed within the interior of the segment of the tube of LLDPE).

The open end of the segment of the tube of LLDPE is sealed to form a generally linear second sealed end, thereby forming an inner bladder, as indicated by block 2110. In one embodiment, one uses a sealing device to heat seal the open end of the segment of the tube of LLDPE to form the generally linear second sealed end (though the open ends of the segments of the tube of LLDPE may be sealed in other suitable manners, such as via adhesive). Sealing the open end forms the inner bladder 2020 of the woven PET dunnage bag 2000. FIG. 10 (as a hidden line) and FIG. 12 show this generally linear second sealed end 2024.

The seals of the inner bladder 2020—i.e., the seals that form the generally linear first and second sealed ends of the tube of LLDPE and the seal that seals the valve assembly to the segment of the tube of LLDPE—are airtight in that air cannot enter or exit the interior of the inner bladder 2020 via these seals.

A segment of the tube of woven PET is cut to a designated length, as indicated by block 2112. In one embodiment, one pulls a tubular woven PET off of a roll to the designated length and uses a cutting device to cut the segment of the tube of woven PET.

A valve-receiving opening that corresponds to the valve-receiving opening of the inner bladder 2020 is formed through the segment of the tube of woven PET, as indicated by block 2114. In one embodiment, one uses a hole-punching device to punch the valve-receiving opening through the hemmed portion of the segment of the tube of woven PET. An automatic hole-punching device may also be used.

The inner bladder is inserted into the interior of the segment of the tube of woven PET (such as by folding the inner bladder, inserting it into the interior of the segment of the tube of woven PET, then unfolding it) such that: (1) the inner bladder is entirely or almost entirely disposed within the interior of the segment of the tube of woven PET, and (2) the valve assembly is received in the valve-receiving opening in the segment of the tube of woven PET such that a portion of the valve assembly passes through the valve-receiving opening and protrudes from the segment of the tube of woven PET, as indicated by block 2116. In one embodiment, one manually inserts the inner bladder 2020 into the interior of the segment of the tube of woven PET and positions the inner bladder 2020 such that the inner bladder 2020 is entirely disposed within the interior of the segment of the tube of woven PET and the valve assembly 2030 is received in the valve-receiving opening of the segment of the tube of woven PET. In some embodiments, the inner bladder is longer than the segment of the tube of woven PET, and one must fold the inner bladder onto itself such that it fits within the interior of the segment of the tube of woven PET and does not interfere with the closing of the ends of the segment of the tube of woven PET (described below).

Each open end of the segment of the tube of woven PET is then closed by: (1) folding one of the end closures (i.e., one of the sheets of woven PET) over that open end; and (2) attaching the end closure to the segment of the tube of woven PET, such as via heat sealing, as indicated by block 2118. This forms generally linear, opposing first and second closed ends 2012 and 2014.

After the open ends are closed, the outer bag 2110 may or may not be airtight.

This process 2000 thus forms the woven PET dunnage bag 2000 including the LLDPE inner bladder 2020 enclosed within the woven PET outer bag 2010.

In various embodiments, the exterior surface of the tube of woven PET is coated with polyethylene (PE), as is one surface of the sheet of woven PET. In these embodiments, the end closures are oriented such that their PE-coated surfaces contact the PE-coated exterior surface of the tube of woven PET to facilitate heat sealing the end closures to the tube of woven PET.

In certain embodiments, the valve assembly is a two-piece assembly that includes first and second separable pieces. In one such embodiment, the first piece of the valve assembly is inserted into the valve-receiving opening of the tube of LLDPE and sealed to the tube of LLDPE. At some point thereafter (such as after the ends of the outer bag are closed), the second piece is attached to the first piece to form the complete valve assembly.

Although the above process was described as employing woven PET, non-woven PET may be used instead. In other embodiments, a combination of woven and non-woven PET may be used.

Various changes and modifications to the present embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A process for manufacturing a dunnage bag, said process comprising:
sealing a first open end of an inner bladder tube segment to form a first sealed end, the inner bladder tube segment including a second open end and having a first length;
forming a valve-receiving opening in the inner bladder tube segment;
inserting at least part of a valve assembly into the valve-receiving opening in the inner bladder tube segment such that a portion of the at least part of the valve assembly protrudes outside the inner bladder tube segment and another portion of the at least part of the valve assembly remains within an interior of the inner bladder tube segment;
sealing the inner bladder tube segment to the at least part of the valve assembly;
sealing the second open end of the inner bladder tube segment to form a second sealed end, thereby forming an inner bladder;
forming a valve-receiving opening through a polyethylene terephthalate tube segment, the polyethylene terephthalate tube segment including spaced-apart first and second open ends and having a second length;
inserting the inner bladder into an interior of the polyethylene terephthalate tube segment such that the at least part of the valve assembly is received in the valve-receiving opening of the polyethylene terephthalate tube segment and part of the at least part of the valve assembly protrudes outside the polyethylene terephthalate tube segment; and
closing the first and second open ends of the polyethylene terephthalate tube segment to form first and second closed ends by attaching first and second end closures to the polyethylene terephthalate tube segment at the respective first and second open ends such that the first and second end closures cover the respective first and second open ends, thereby forming an outer bag that encloses the inner bladder.

2. The process of claim 1, wherein each end closure is made from a sheet of polyethylene terephthalate.

3. The process of claim 1, which includes sealing the first open end of the inner bladder tube segment, sealing the second open end of the inner bladder tube segment, and sealing the inner bladder tube segment to the at least part of the valve assembly using one or more heat sealing devices.

4. The process of claim 1, which includes cutting the inner bladder tube segment and sealing the first open end of the inner bladder tube segment using a combination cutting and sealing device.

5. The process of claim 1, which includes forming the valve-receiving openings in the inner bladder tube segment and the polyethylene terephthalate tube segment using one or more hole-punching devices.

6. The process of claim 1, wherein the first and second sealed ends of the inner bladder are generally linear.

7. The process of claim 1, wherein the first and second sealed ends of the inner bladder are airtight and the first and second closed ends of the outer bag are not airtight.

8. The process of claim 1, wherein closing the first and second open ends of the polyethylene terephthalate tube segment includes heat sealing the first and second end closures to the polyethylene terephthalate tube segment.

9. The process of claim 1, wherein the polyethylene terephthalate tube segment is formed from circular loomed woven polyethylene terephthalate.

10. A dunnage bag comprising:
an inner bladder;
an outer bag enclosing the inner bladder, the outer bag formed from a tube of polyethylene terephthalate and two end closures attached to and closing respective opposing open ends of the tube of polyethylene terephthalate; and
a valve assembly protruding from the outer bag and fluidically connected to an interior of the inner bladder.

11. The dunnage bag of claim 10, wherein the inner bladder is formed from linear low-density polyethylene.

12. The dunnage bag of claim 11, wherein the tube of polyethylene terephthalate is circular-loomed woven polyethylene terephthalate.

13. The dunnage bag of claim 10, wherein the tube of polyethylene terephthalate is circular-loomed woven polyethylene terephthalate.

14. The dunnage bag of claim 10, wherein the two end closures are attached to the tube of polyethylene terephthalate tube via heat sealing.

15. The dunnage bag of claim 10, wherein an exterior surface of the tube of polyethylene terephthalate is at least partially coated with polyethylene and a surface of each end closure that contacts the exterior surface of the tube of polyethylene terephthalate is at least partially coated with polyethylene.
